(19) United States
(12) Patent Application Publication
(10) Pub. No.: US 2003/0078996 A1
(43) Pub. Date: Apr. 24, 2003

(54) EnsoBox clustered services architecture: techniques for enabling the creation of scalable, robust, and industrial strength internet services provider appliance

(75) Inventor: David A. Baldwin, Rockville, MD (US)

Correspondence Address: Ensoport Internetworks, Suite 300, 2401 Pennsylvania Ave, NW, Washington, DC, 20037, US

(73) Assignee: Ensoport Internetworks, Washington, DC

(21) Appl. No.: 09/975,955

(22) Filed: Oct. 15, 2001

(51) Int. Cl. G06F 15/173; H04B 1/74

(52) U.S. Cl. 709/220; 714/4

(57) ABSTRACT

Disclosed is a method that defines a standard configuration useful for scaling services independently. This method makes efficient use of the Network, Server and Storage layers of a computing infrastructure in such a way that services can be clustered. These clustered services allow for redundancy in hardware and software and take full advantage of the hardware and software to increase customer performance and throughput. By making appropriate use of inexpensive servers, network attached storage, virtual local area networks, content switching and service clustering, Internet services can be scaled incrementally as customer demand grows. This method is efficient and relatively affordable.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Technical Field of Invention

Clustered Services Architecture describes a configuration of computing devices that allow for the delivery of reliable services to Internet users. This configuration deals with the problems of service scalability, performance, redundancy and fault tolerance. This configuration works with computing technologies such as virtual local area networking, network attached storage, distributed computing and clustering of services.

2. Description of Related Art

U.S. Patent Documents

| | | |
|---|---|---|
| 6,122,756 | September 2000 | Baxter, et al. |
| 5,862,312 | January 1999 | Mann, et al. |
| 5,202,980 | April 1993 | Morita, et al. |
| 6,128,277 | October 2000 | Bruck, et al. |
| 5,361,347 | November 1994 | Glider, et al. |
| 5,841,775 | November 1998 | Huang |
| 6,253,230 | June 2001 | Couland, et al. |
| 6,141,759 | October 2000 | Braddy |

The Problem: Building the Best Architecture to Deliver Internet Services

An Internet Service Provider (ISP) delivers Internet services to businesses and consumers. Internet services are applications that are offered to users over the Internet. These services include, but are not limited to, dial-up IP, email, chat, portal, electronic commerce and news. When building architecture to deliver these Internet services, the following issues arise:

It is difficult to scale the infrastructure to support growing user bases and additional Internet services.

Services rely on computer hardware and computer hardware fails quite often, creating costly downtime.

Due to the nature of Internet services and increasing savvy of Internet users, security is difficult to manage.

Finding technical talent capable of managing the system resources is increasingly difficult.

Two Typical Approaches

Enterprise Solutions

The use of enterprise class hardware and software is becoming the standard for building architecture to support Internet services. The term enterprise typically refers to larger corporations, so enterprise hardware and software is geared toward larger corporations.

Enterprise platforms have a number of features that benefit the service provider market. Enterprise hardware platforms scale easily. Additional modules that carry additional capacity or functionality can be added to most enterprise hardware platforms. Due to technology advances such as hot swapping hardware, it becomes practical to scale the enterprise hardware platform. Also, redundancy of hardware minimizes potential system downtime.

Enterprise software platforms are deployed on enterprise hardware platforms. They rely on the enterprise hardware for scale. Enterprise software platforms can be tuned and optimized for these hardware platforms. Various enterprise hardware and software must be tightly integrated to provide architecture capable of delivering Internet services.

The largest benefit to using enterprise class hardware and software are the corporate alliances that the enterprise solution providers bring with them. These alliances bring network, storage, server and software companies together to provide a solution for vertical market segments. There are several enterprise solutions for the service provider market.

FIG. 1, provides a typical example of an enterprise solution geared towards the service provider market. The architecture described is capable of providing Internet services in a reliable manner. The servers are standard enterprise servers clustered together with software. The storage is arranged in a standard Storage Area Networks (SAN) design. The router and switch are assumed fault-tolerant and could be duplicated for redundancy. This architecture (hardware and software) can be purchased within a six hundred thousand dollar price point.

It would appear that an enterprise solution would be the best option for delivering Internet services in a reliable manner; however, it is an extremely expensive option.

Due to extreme cost concerns, it is difficult for the service provider industry to make use of enterprise solutions. Service providers require hardware and software solutions that grow incrementally so that the cost of their architecture will only be incurred as their customer base and revenues grow. Due to these cost concerns, a completely new architecture should be built so that the service provider can grow incrementally.

Teamwork Approach

Due to the price of enterprise solutions, service providers have turned to integrating existing low-end hardware and software in order to deliver reliable Internet services.

Service providers have recognized that enterprise solutions are overkill for their needs. The margin on low-end hardware and software is much less than enterprise hardware and software, so the price point for low-end hardware and software is decreasing daily. This makes low-end hardware and software integration appear to be a lucrative option for the service provider market.

The teamwork approach to creating architecture capable of providing Internet services is extremely labor intensive. A strong team of engineers can integrate low-end hardware in order to provide architecture for a service provider. They can build a system to provide reliable Internet services by using a combination of inexpensive servers, storage and network devices.

Scaling is simply a matter of adding more low-end hardware to the mix. The team develops methods for capacity planning and performance monitoring in order to incrementally scale the architecture. They also devise a monitoring procedure and will respond quickly to system failures.

A strong team of engineers can also integrate existing custom off the shelf (COTS) software in order to deliver reliable Internet services. There is a variety of low-end software that will provide Internet services. In fact, much of this software is available from various public domain sources. This software can be integrated with external scripts and programs written by the service provider's engineering staff in order to provide a full suite of Internet services.

While there is a large savings from utilizing low-end hardware and software, the teamwork approach is not without significant costs. This approach is extremely labor intensive. Good engineering talent is very expensive in today's technical market place.

Since the individual technology companies have not formed alliances to deliver lower-end solutions, there is no standard for this approach. Due to the lack of standardization, greater effort is required to design, deploy, and administer this architecture. As this type of architecture grows, the engineering staff resource requirements, and cost of those resources will grow exponentially.

Summary of Two Typical Approaches

Enterprise solutions and teamwork solutions are both good approaches for deploying infrastructure to support service provider offerings. However, each option is not without costly downsides.

Enterprise solutions bring best of breed hardware and software together in a standard way to provide Internet services. This standardization enables ease of scale and administration thus limiting the necessity for large amounts of engineering staff resources. However, enterprise solutions are extremely pricey due to the high cost of enterprise class hardware and software.

The teamwork solution makes use of the lower end hardware and software, but it requires large amounts of engineering staff resources due to the lack of corporate alliances and standardization. Since engineering staff is quite expensive and difficult to obtain, this option will be extremely pricey and very time consuming.

FIG. 2, summarizes the individual PROS and CONS of each approach.

The key to leveraging the advantages of each approach, is standardization. Lower-end hardware and software can be integrated to accomplish the same end goal as standard enterprise solutions. However, standardization is critical to create ease of scale and administration and to reduce costs by limiting the need for large amounts of technical staff. A company should take the initiative to create a standard platform that integrates the lower-end hardware and software from best of breed hardware and software manufacturers. This integration should be geared towards a standard platform for the service provider industry.

### BRIEF SUMMARY OF THE INVENTION

Clustered Services Architecture (CSA) defines a standard architecture for the service provider market. This approach integrates best of breed hardware and software to provide an architecture capable of delivering Internet services in a reliable manner. CSA combines the benefits of enterprise solutions and the teamwork approach in a much more cost efficient way. The CSA:

scales independently and incrementally as the customer base and service offerings grow. uses lower-end hardware and software from best of breed hardware and software manufacturers. and is designed to fit the specific needs of the service provider market.

At the heart of CSA are two methods, each with important benefits: the Well Defined Architecture and Services Clustering. The Well Defined Architecture standardizes the hardware in CSA. It is a standard architecture for integrating lower-end hardware from best of breed hardware manufacturers for service providers. This architecture uses open system standards throughout the integration process, ensuring that there is no dependency on a particular hardware vendor. It is possible to use any hardware vendor that adheres to the open standard.

The second method is known as Services Clustering. Services Clustering defines the software architecture component of CSA. This method sets standards for the deployment of the back-end and front-end software required to enable Internet services. This method groups services together to make efficient use of the standard hardware architecture (Well Defined Architecture).

### BRIEF DESCRIPTION OF THE SEVERAL VIEWS OF THE DRAWING

For a fuller understanding of the present invention, reference is made to the following detailed description taken in conjunction with the accompanying drawing figures wherein like reference character denote corresponding parts throughout the several views and wherein:

FIG. 1 is an example of a typical enterprise architecture;

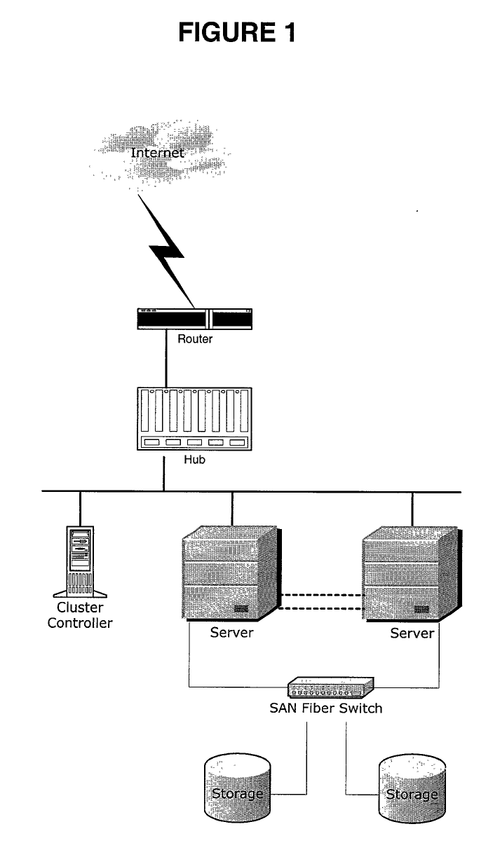

FIG. 2 is a summary of the PROs and CONs of existing approaches to problem;

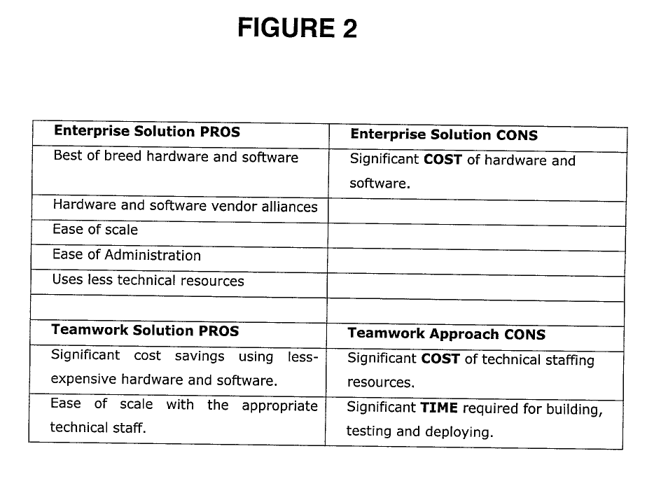

FIG. 3 describes the three layers of the well-defined architecture;

FIG. 4 details the difference between services clustering and non-clustering;

### DETAILED DESCRIPTION OF THE INVENTION

Clustered Services Architecture (CSA) defines a standard architecture for the service provider market.

This approach integrates best of breed hardware and software to provide an architecture capable of delivering Internet services in a reliable manner. CSA combines the benefits of enterprise solutions and the teamwork approach in a much more cost efficient way. The CSA:

scales independently and incrementally as the customer base and service offerings grow. uses lower-end hardware and software from best of breed hardware and software manufacturers. and is designed to fit the specific needs of the service provider market.

At the heart of CSA are two methods, each with important benefits: the Well Defined Architecture and Services Clustering. The Well Defined Architecture standardizes the hardware in CSA. It is a standard architecture for integrating lower-end hardware from best of breed hardware manufacturers for service providers. This architecture uses open system standards throughout the integration process, ensuring that there is no dependency on a particular hardware vendor. It is possible to use any hardware vendor that adheres to the open standard.

The second method is known as Services Clustering. Services Clustering defines the software architecture component of CSA. This method sets standards for the deployment of the back-end and front-end software required to enable Internet services. This method groups services together to make efficient use of the standard hardware architecture (Well Defined Architecture).

Well Defined Architecture

The Well Defined Architecture standardizes the three layers of hardware necessary to deliver reliable Internet services. Each hardware layer works together to provide a complete hardware architecture for service providers. The three layers are:

Network Layer—a combination of network resources that enables the customer to access the services (i.e. switches and routers).

Server Layer—a combination of server equipment that serves the services to the customer (i.e.

Unix servers).

Storage Layer—a combination of disk resources that stores information that the services require.

The well-defined architecture is designed to make efficient use of the system resources. This architecture makes use of proven technology to tightly integrate the three tiers. Each tier can scale independently and operate efficiently.

Network Layer

The Well Defined Architecture standardizes the Network Layer with two technologies.

Virtual Local Area Networks (VLAN) are used at Open System Interconnection (OSI) Layer 2 and 3 (Data Link and Network) in order to make efficient use of the network resources.

Switching on a network inherently speeds up network performance.

VLAN's allow for an inexpensive, flexible way to modify logical groups in changing environments.

VLAN's operate independently of the physical medium; which will allow the network to be upgraded with no impact to the existing Internet services.

VLAN's also add additional data security to the Network Tier.

Load Direction and Content Switching is used at OSI Layer 2,3,5 and 7 (Data Link, Network, Session and Application). Load Direction is used to direct Internet service users to one server from a pool of servers. Content switching:

allows the users to be directed to the most available server in the pool.

enables persistence such that the user is continuously directed back to the server initially chosen for a finite period of time.

Server Tier

CSA approaches the Server Tier with a technology called ensoRAIS (ensoport.com, Inc.'s Redundant Array of Inexpensive Servers). This technology is based on using a group of inexpensive servers as opposed to a small number of enterprise class servers. Each server has an exact replica of the software required to host a service. Because of this, users can access any of the servers and utilize the Internet services. Each server in the ensoRAIS design is configured exactly like every other server. In the event that more server resources are necessary, it is easy to add another server to the configuration without impacting the existing traffic on the current servers.

Storage Tier

CSA standardizes the Storage Tier with Network Attached Storage (NAS) technology. Network Attached Storage introduces a high-performance, highly reliable device that is dedicated to providing storage over a network. NAS devices have a single purpose operating system that reduces the overhead of reading and writing data from the storage medium. Adding more disks can scale these devices. They operate independently of the server that requires the information that they store.

Within CSA, the server layer accesses information from the NAS devices using Network File System (NFS). NFS maintains file integrity so that files will not be corrupted when multiple machines attempt to access them at the same time.

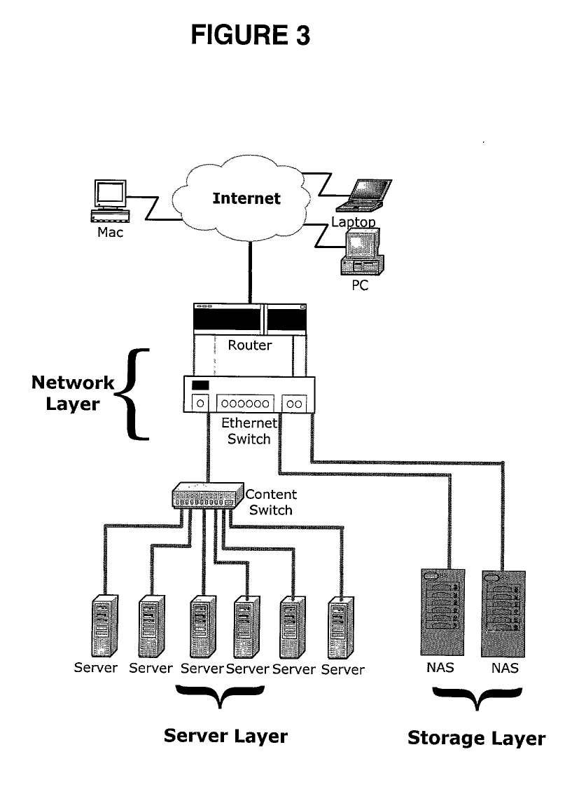

FIG. 3, provides a graphical representation of hardware that used at each of the three hardware layers.

Services Clustering

While the Well Defined Architecture standardizes the hardware requirement, Services Clustering standardizes the software requirement. This method “clusters” the services, that is to say, it groups the services together to make the most efficient use of the standard architecture (The Well Defined Architecture). The key to Services Clustering is the Service Package and Service Management.

Service Package

The service package is one copy of all of the software required to deliver every Internet service offered by the service provider. Each Internet service will require one or more pieces of software in order to operate. For example Internet email will require a mail transport agent software, a message access software and a web software. Similarly, Internet Chat will require a back-end chat daemon software and a front-end chat client. Using CSA, we create an Internet service package that includes all of the software required for email and all of the software required for chat. We then load this package onto every machine at the Server Layer of the Well Defined Architecture.

The Content Switching at the Network Layer of the Well Defined Architecture directs users to the least loaded machine running the service package. For example, if a user wanted to use Internet Chat, they would be directed to the least loaded machine at the Service Layer. Because the software required to use chat is loaded on every machine at the Server Layer, every machine is capable of providing the service.

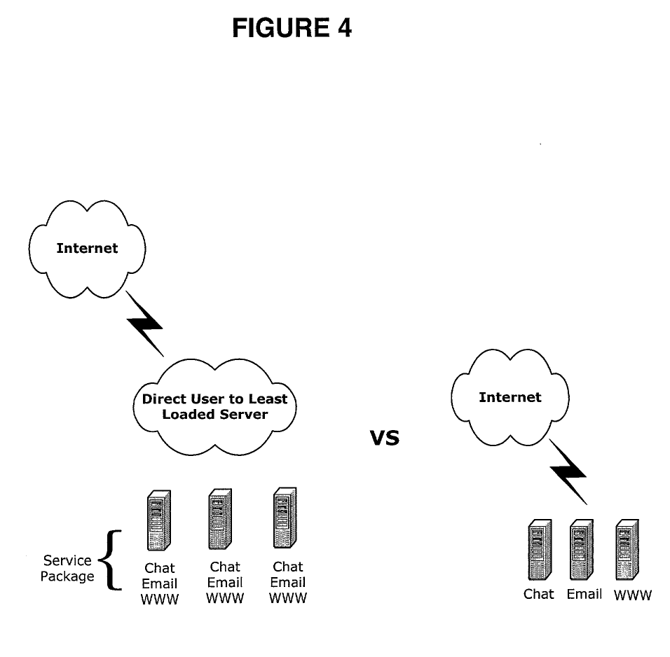

FIG. 4, details the difference between using Services Clustering to offer Internet services and a non-clustered approach.

Service Management

Service Management maintains independent server configurations and automatically installs updates (i.e. Security Patches, Bug Fixes, etc...) all software included in the Service Package. This is accomplished through the use of remote software distribution. A gold copy of the service package is maintained, updated and tested. After testing in a vanilla environment, updates can be easily pushed to the Server Layer of the Well Defined Architecture.

Creating a package of all software required to run all Internet services offered by the service provider is not difficult, but the configuration of each software package must differ slightly on each machine. For example, each server will have a different hostname and that hostname must be stored in a configuration file. Service Management resolves this issue by maintaining configuration files for all software on a machine independent basis. By maintaining a simple database of configuration files, changes to configuration files can be tracked and updated automatically.

Benefits

CSA is an extremely efficient model designed primarily for the service provider market. The primary benefits gained from CSA include cost savings, staff resource reduction, scalability, and fault tolerance.

Cost Savings

The use of CSA standard by a service provider will greatly reduce the initial investment in infrastructure hardware. Because of the Well Defined Architecture, the service provider is able to purchase only the computer hardware needed to begin offering Internet services. The service provider can then incrementally add additional hardware to each layer of the Well Defined Architecture as the hardware is needed. By incurring infrastructure cost incrementally, the service provider will be able to build profits faster and turn more resources back into growing the business and enhancing value to the customer.

Staffing Resource Reduction

Standardizing hardware (Well Defined Architecture) and utilizing Service Management (Services Clustering), have the benefit of minimizing technical staffing requirements.

Overall administration is made easier because all hardware at each layer of the Well Defined Architecture is configured in exactly the same manner. Service Management keeps configuration differences and changes in a centralized location for easy administration. It also allows for a centralized software upgrade strategy. By making overall administration easy, the service provider can shift resources and staff to value added activities and positions such as sales and customer care.

Scalability

The CSA is incrementally scalable due to the modularity in the Well Defined Architecture and the Service Package offered by Services Clustering. The Well Defined Architecture allows the service provider to incrementally add hardware to each hardware layer as additional resources and capacity is required. By creating a Service Package that consolidates all software required for every Internet service offered, the service provider can add hardware resources to the Server Layer in real time without impacting current users. Increasing demand for internet services in markets around the world makes incremental scalability one of the most important benefits of CSA.

Fault Tolerance

Fault Tolerance is accomplished by CSA through redundancy. Redundancy is accomplished by the modularity in the Well Defined Architecture and the Service Package offered by Services Clustering. The Well Defined Architecture breaks each hardware layer into an independent group. The individual pieces of hardware required at each layer are redundant. By loading the one Service Package on all machines at the Server Layer, several machines can fail and users will be directed to the remaining (normal functioning) servers until hardware failure can be resolved. The service provider will ensure customer satisfaction by meeting extremely high Quality of Service levels and system uptimes.

Summary

Clustered Services Architecture is a cost and time efficient solution for deploying service provider architecture. This solution provides scalability, fault tolerance and reduces staffing requirements. The key to this solution is standardization and the ability to add hardware and software incrementally.

1. We claim a method for creating a well-defined architecture that combines configurations at the network, server and storage tier of an infrastructure in order to provide for scalability of services incrementally, increased performance, and enhanced security made up of the following configuration tasks:
(a) Configuring several Virtual Local Area Network (VLAN) segments in order to separate traffic from server to disk, from content switch to server, from user or WAN connected ethernet segment to content switch.
(b) Configuration of router access lists such that traffic is protected across the above mentioned VLAN segments.
(c) Configuration of many redundant inexpensive server machines.
(d) Above mentioned machines are configured exactly the same (memory, CPU, disk).
(e) Each server contains the exact software image of all other servers and machine dependent configurations are stored in LDAP.
(f) Configuration of Network Attached Storage (NAS) technology along with Network File System (NFS) such that machines can share storage and file locking is managed via NFS.
(g) This storage is configured in a Redundant Array of Inexpensive Disk (RAID) configuration.

2. We claim that in order to make use of the method in claim 1, method for grouping or clustering software together is described as follows:
(a) Each server mentioned in claim 1 will have an exact copy of the complete software grouping.
(b) The software grouping consists of an Email MTA, Web-based email front-end, POP daemon, IMAP daemon, Chat daemon, Web daemon, backup server software, monitoring daemon and agents, Web-based content portal, and additional software as it becomes useful to users of service providerships.
(c) Users of the system will be directed to the least loaded and most available server by way of a content switch.
(d) Any server will be able to handle the user request for service or software application.
(e) Software can be added to the grouping at any time after it has been through a full level of quality assurance testing.
(f) After new software, bug fixes or security updates have been through a full level of quality assurance testing, they can automatically be pushed to the hardware devices within the architecture defined by claim 1.
(g) A Lightweight Directory Access Protocol (LDAP) configuration database will store any independent server configurations that will identify slight differences in the software.
(h) Above mentioned LDAP configuration database will not impact the software grouping at all, but will serve to extend the grouping.

3. We claim that the methods in claims 1 and 2 will significantly decrease cost, increase scalability, increase redundancy and enhance security.
